(19) United States
(12) Patent Application Publication
(10) Pub. No.: US 2022/0375218 A1
(43) Pub. Date: Nov. 24, 2022

(54) MONITORING SYSTEM CONFIGURED TO MONITOR AN AREA OF INTEREST

(71) Applicant: DELTA DRONE, Dardilly (FR)

(72) Inventors: Pierre BLOUET, Nantes (FR); Philippe BARANGER, La Haye Fouassière (FR)

(21) Appl. No.: 17/771,362

(22) PCT Filed: Oct. 22, 2020
(86) PCT No.: PCT/FR2020/051907

§ 371 Date: Apr. 22, 2022

(30) Foreign Application Priority Data
Oct. 22, 2019 (FR) 1911813

(51) Int. Cl. G06V 20/10; G06V 20/52

(52) U.S. Cl. CPC G06V 20/176; G06V 20/52

(57) ABSTRACT

The monitoring system includes a support device which is displaceable, a mast which is supported by the support device, and a stabilization device configured to vertically stabilize the mast during displacements of the support device, the stabilization device including a plurality of support arms which are fastened to the mast and which are angularly offset from each other, and a plurality of air flow generation devices that are fastened to the support arms.

### CROSS REFERENCE TO RELATED APPLICATIONS

This application is a National Stage of PCT Application No. PCT/FR2020/051907 filed on Oct. 22, 2020, which claims priority to French Patent Application No. 19/11813 filed on Oct. 22, 2019, the contents each of which are incorporated herein by reference thereto.

### TECHNICAL FIELD

The present invention concerns a monitoring system configured to monitor an area of interest located near the monitoring system.

### BACKGROUND

In order to monitor an area of interest located at a height, and in particular in order to monitor the operation state of a smoke detection device, it is in particular known to use a lifting device, such as an aerial lift, in order to allow an operator to spray smoke near the smoke detection device in order to test its correct operation.

Nonetheless, such a lifting device, due to its bulk, may not be used in areas that are difficult to access.

Such a lifting device may for example be replaced by a monitoring system including a support device which is displaceable, a mast which is supported by the support device, and a smoke spraying device fastened to the mast and configured to spray smoke near the smoke detection device.

However, when such a monitoring system is used to monitor a smoke detection device located at a significant height, it is necessary to use a large-sized mast. The use of a large-sized mast on the one hand requires a large-sized and heavy weight support device in order to avoid any tilting of the mast, for example, during a sudden stop of the support device, and on the other hand requires equipping the monitoring system with a complex guying system in order to vertically stabilize the mast during the displacements of the support device and to stiffen the mast.

Yet, the use of a bulky support device does not enable the monitoring system to easily move in narrow aisles of a building, and the presence of a complex guying system significantly increases the costs of the monitoring system and complicates the assembly of the latter.

A monitoring system similar to that previously described may also be used to monitor the quality of an environment, and in particular the quality of air of said environment, or to monitor the structural state of a building. To this end, the mast is equipped, instead of the smoke spray device, with at least one environmental sensor configured to detect the presence of predetermined particles in the air, and/or with at least one capturing device configured to capture images of the building.

For the same reasons as those previously mentioned for the monitoring of smoke detection devices located at height, such a monitoring system must be equipped with a large-sized and heavy weight support device and a complex guying system when it is desired to monitor the quality of air at a great height or to capture high-quality or great-height images. Indeed, in the absence of a complex guying system, irregularities in the floor could be transmitted to the mast when the support device moves and could affect the quality of the images taken.

### BRIEF SUMMARY

The present invention aims at overcoming all or part of these drawbacks.

The technical problem underlying the invention therefore consists in providing a monitoring system which has a simple and economical structure, while making it possible to easily and reliably monitor an area of interest.

To this end, the present invention concerns a monitoring system configured to monitor an area of interest located near the monitoring system, the monitoring system including:
a support device which is displaceable,
a mast which is supported by the support device, and
a stabilization device configured to vertically stabilize the mast during displacements of the support device, the stabilization device including a plurality of support arms which are fastened to the mast and which are angularly offset from each other, and a plurality of air flow generation devices which are fastened to the support arms.

Such a configuration of the monitoring system, and in particular the presence of a stabilization device equipped with air flow generation devices, allows significantly reducing the size and the weight of the support device which supports the mast, allows getting rid of a guying system to vertically stiffen the mast, while being able to use a high mast.

In particular, the significant reduction in the size of the support device allows significantly reducing the bulk of the monitoring system, and therefore making the monitoring system moves in narrow areas.

In addition, the presence of air flow generation devices allows stabilizing the mast, for example, in a vertical position regardless of the fluctuations in trajectories, speeds, accelerations of the support device.

Thus, the monitoring system according to the present invention has a simple and economical structure, while making it possible to reliably and easily monitor an area of interest.

The monitoring system may further have one or more of the following features, considered alone or in combination.

According to an embodiment of the invention, the area of interest is a surrounding structure located near the monitoring system, and/or a device to be monitored located near the monitoring system and/or an environment located around the monitoring system.

According to an embodiment of the invention, the monitoring system is configured to monitor a structural state of the surrounding structure, and/or to monitor an operation state of the device to be monitored and/or to monitor the quality of the environment, and for example the quality of the air of the environment.

According to an embodiment of the invention, the surrounding structure is a building, such as a house, a factory, a warehouse, an office building or even a dwelling building. Advantageously, the monitoring system is configured to monitor the facade of the building, and for example to detect defects in the facade of the building.

According to an embodiment of the invention, the surrounding structure is a quarry. Advantageously, the monitoring system is configured to monitor a working face of the quarry, and for example to detect defects in the working face.

According to an embodiment of the invention, the device to be monitored is a smoke detection device. Advantageously, the monitoring system is configured to monitor an operation state of the smoke detection device. To this end, the monitoring system includes a smoke spray device configured to spray smoke near the smoke detection device. Advantageously, the smoke spray device securely moves with the mast, and may for example be fastened to the mast or to one of the support arms.

According to an embodiment of the invention, the monitoring system includes at least one environmental sensor configured to detect the presence of predetermined particles in the air, and for example toxins, pollutants, chemicals, smoke.

According to an embodiment of the invention, the stabilization device includes a central portion which is fastened to the mast, the support arms being fastened to the central portion.

According to an embodiment of the invention, the support arms extend in the same extension plane.

According to an embodiment of the invention, each air flow generation device includes a propeller. Advantageously, the axis of rotation of each propeller is substantially parallel to the direction of extension of the respective support arm.

According to an embodiment of the invention, each air flow generation device includes a drive motor configured to drive the respective propeller in rotation.

According to an embodiment of the invention, the stabilization device is a drone.

According to an embodiment of the invention, the mast is connected to the support device by an articulation with at least two degrees of freedom.

According to an embodiment of the invention, the articulation with at least two degrees of freedom is configured to enable a pivoting of the mast relative to the support device about a first pivot connection and about a second pivot connection substantially perpendicular to the first pivot connection.

According to an embodiment of the invention, the first and second pivot connections extend transversely, and for example perpendicularly, to a longitudinal axis of the mast.

According to an embodiment of the invention, the first and second pivot connections are configured to enable roll and pitch movements of the mast.

According to an embodiment of the invention, a counterweight is fastened to a lower portion of the mast, the counterweight being configured so as to place the center of gravity of the set formed by the mast and the counterweight near the articulation with two degrees of freedom.

According to an embodiment of the invention, the articulation incudes a first fastening part which is annular and which is mounted articulated on the support device about a first articulation axis, and a second fastening part which is annular and which is mounted articulated on the first fastening part about a second articulation axis, the second fastening part extending about the mast and being fastened to the mast.

According to an embodiment of the invention, the mast is configured such that the center of gravity of the mast is located substantially at the articulation with at least two degrees of freedom, and for example at a height comprised between 1.5 and 2 m with respect to the ground in conditions of use of the monitoring system.

According to an alternative of the invention, the articulation with at least two degrees of freedom is an articulation with three degrees of freedom, in other words a ball joint.

According to an embodiment of the invention, the mast is configured to occupy a first mast position in which the mast extends substantially vertically, and a second mast position in which the mast extends substantially horizontally. These arrangements allow facilitating the passage of the monitoring system, for example, at the level of an access door of a building, in particular to displace the monitoring system between two contiguous buildings, quite simply by displacing the mast into the second mast position.

According to an embodiment of the invention, the counterweight is located below the articulation with at least two degrees of freedom when the mast occupies the first mast position.

According to an embodiment of the invention, the monitoring system includes a movement limiting device configured to limit an amplitude of movement of the mast relative to the support device when the mast occupies the first mast position.

According to an embodiment of the invention, the movement limiting device is configured to limit an amplitude of movement of the mast about the first pivot connection, and for example of the first articulation axis, when the mast occupies the first mast position, and to limit an amplitude of movement of the mast about the second pivot connection, and for example the second articulation axis, when the mast occupies the first mast position.

According to an embodiment of the invention, the movement limiting device is provided on the support device.

According to an embodiment of the invention, the movement limiting device is configured to trigger an emergency stop of the monitoring system.

According to an embodiment of the invention, the monitoring system includes an immobilization device configured to immobilize the mast with respect to the support device when the mast occupies the second mast position.

According to an embodiment of the invention, the stabilization device includes at least one movement sensor configured to detect movements of the mast with respect to the support device, the stabilization device being configured to control the air flow generation devices according to the movements detected by the at least one movement sensor.

According to an embodiment of the invention, the stabilization device includes at least one movement sensor configured to detect movements of the mast with respect to the terrestrial frame of reference, the stabilization device being configured to control the air flow generation devices according to the movements detected by the at least one movement sensor.

According to an embodiment of the invention, the at least one movement sensor is located near the articulation with at least two degrees of freedom.

According to an embodiment of the invention, the stabilization device includes an inertial unit which is arranged near the articulation with at least two degrees of freedom, the stabilization device being configured to control the air flow generation devices according to the data detected by the inertial unit.

According to an embodiment of the invention, the stabilization device includes an automatic pilot (“autopilot”) which is configured to transmit control signals to the air flow generation devices. Advantageously, the automatic pilot is located near the articulation with at least two degrees of freedom. The control signals are for example defined according to the data detected by the inertial unit.

According to an embodiment of the invention, the stabilization device is configured to control the propellers of the stabilization device according to the movements detected by the at least one movement sensor, and for example according to the data detected by the inertial unit.

According to an embodiment of the invention, the mast is at least partially formed by an assembly of mast sections which are removably nested into each other.

According to an embodiment of the invention, the mast has a length greater than six meters, and for example about ten meters.

According to an embodiment of the invention, the mast is equipped with at least one image capturing device configured to capture images of the area of interest.

According to an embodiment of the invention, the at least one image capturing device includes a digital photographic camera or a digital camera.

According to an embodiment of the invention, the monitoring system includes a plurality of image capturing devices which are offset with respect to each other along a longitudinal axis of the mast.

According to an embodiment of the invention, the support device is equipped with casters configured to roll on the ground on which the support device is intended to be displaced.

According to an embodiment of the invention, the support device is a support carriage.

According to an embodiment of the invention, the monitoring system further includes an autonomous robotic device configured to move autonomously, the support device being integral in movement with the autonomous robotic device.

According to an embodiment of the invention, the autonomous robotic device is equipped with casters configured to roll on the ground.

According to an embodiment of the invention, the autonomous robotic device is equipped with a rechargeable battery.

According to an embodiment of the invention, the autonomous robotic device includes exteroceptive sensors configured to detect information on an environment in which the autonomous robotic device is located.

According to an embodiment of the invention, the exteroceptive sensors include at least one LI DAR sensor.

According to an embodiment of the invention, the exteroceptive sensors are configured to detect obstacles located on the path of movement of the autonomous robotic device.

According to an embodiment of the invention, the support device is configured to be at least partially supported by the autonomous robotic device.

According to an embodiment of the invention, the support device is configured to be towed or pushed by the autonomous robotic device.

According to an embodiment of the invention, the support device is configured to be fastened to a vehicle, and for example to a motor vehicle, and in particular a power-driven vehicle, such as a car, a truck or an all-purpose vehicle.

According to an embodiment of the invention, the mast includes a telescopic upper portion. These arrangements allow in particular setting the height of the mast in order to facilitate the circulation of the monitoring system, for example in buildings equipped in particular with ventilation ducts.

According to an embodiment of the invention, the telescopic upper portion is equipped with at least one image capturing device.

According to an embodiment of the invention, the telescopic upper portion is located above the air flow generation devices.

According to an embodiment of the invention, the telescopic upper portion may be deployed between a deployed configuration and a retracted configuration according to a direction of deployment which is substantially parallel to the longitudinal axis of the mast.

According to an embodiment of the invention, the monitoring system comprises at least one light source fastened to the mast. The at least one light source is for example configured to illuminate an illumination area located in a field of vision of the at least one image capturing device in order to improve the quality of the images captured by the at least one image capturing device.

According to an embodiment of the invention, the at least one light source includes at least one light-emitting diode, and may for example be a light-emitting diode flash.

In the present document, the monitoring of an area of interest excludes performing of a warehouse inventory, and in particular the performance of an inventory of stored objects. Thus, the area of interest cannot be stored objects, and in particular objects stored on shelves arranged in a storage area of a warehouse.

### BRIEF DESCRIPTION OF THE DRAWINGS

Anyway, the invention will be well understood from the following description with reference to the appended schematic drawings representing, as non-limiting examples, several embodiments of this monitoring system.

FIG. 1 is a perspective view of a monitoring system according to a first embodiment of the invention.

FIG. 2 is a partial perspective view of a lower portion of the monitoring system of FIG. 1.

FIG. 3 is a partial perspective view of a stabilization device of the monitoring system of FIG. 1.

FIG. 4 is a partial perspective view of a mast of the monitoring system of FIG. 1.

FIG. 5 is a perspective view of the articulation with two degrees of freedom of the monitoring system in FIG. 1.

FIG. 6 is a partial perspective view of the monitoring system of FIG. 1 showing the mast in the second mast position.

FIG. 7 is a perspective view of a telescopic upper portion of the monitoring system of FIG. 1, showing the telescopic upper portion in a retracted configuration.

FIG. 8 is a perspective view of the telescopic upper portion of FIG. 7 in an intermediate configuration.

FIG. 9 is a perspective view of the telescopic upper portion of FIG. 7 in a deployed configuration.

FIG. 10 is a partial perspective view of a monitoring system according to a second embodiment of the invention.

FIG. 11 is a partial perspective view of a monitoring system according to a third embodiment of the invention.

FIG. 12 is a perspective view of a monitoring system according to a fourth embodiment of the invention.

### DETAILED DESCRIPTION

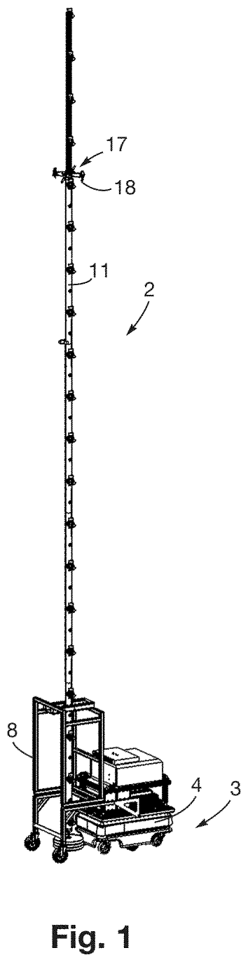

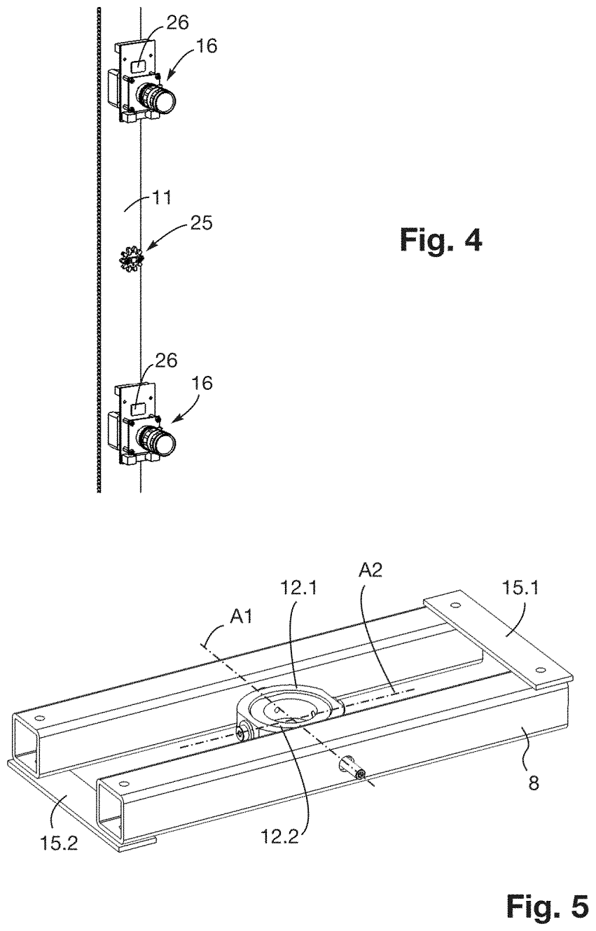

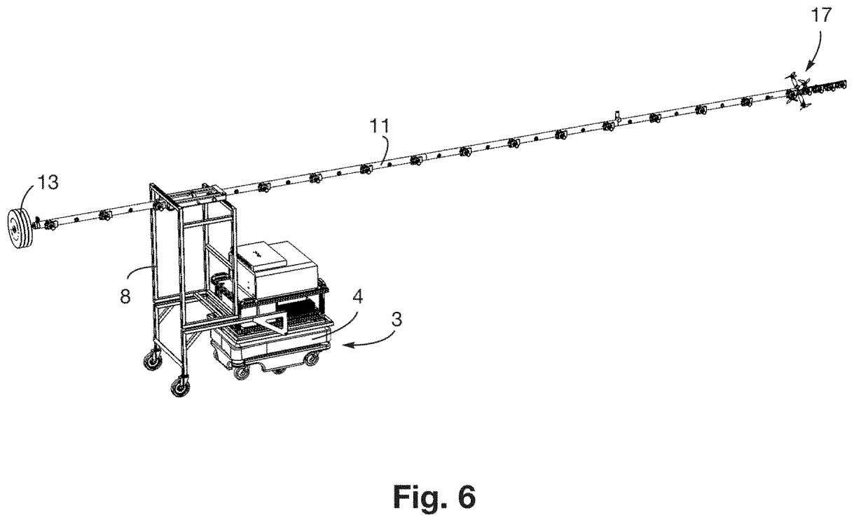

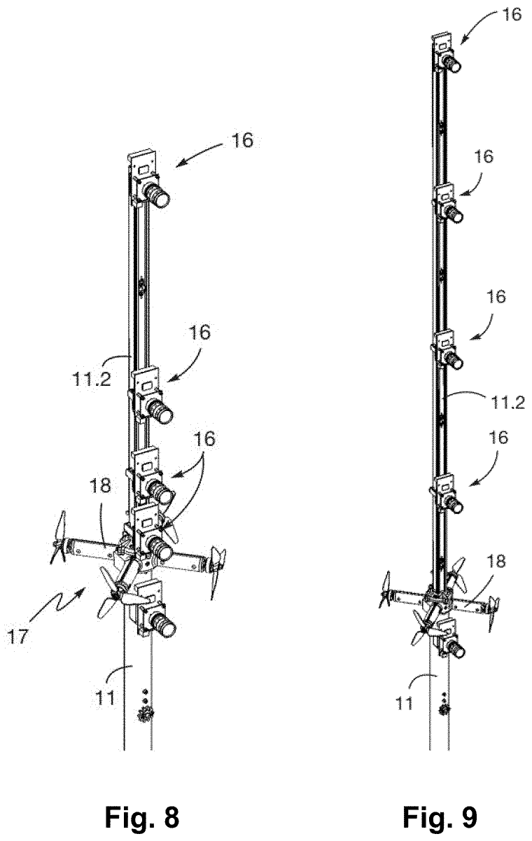

FIGS. 1 to 9 represent a monitoring system 2 according to a first embodiment of the invention which is configured to monitor an area of interest located near the monitoring system. According to the first embodiment of the invention, the area of interest is advantageously a surrounding structure 20 located near the monitoring system, and the monitoring system 2 is configured to monitor a structural state of the surrounding structure.

According to the embodiment represented in FIGS. 1 to 9, the monitoring system 2 includes an autonomous robotic device 3 configured to move autonomously according to a predefined movement path. The autonomous robotic device 3 includes a support frame 4 including casters 5 configured to roll on the ground located near the area of interest.

The autonomous robotic device 3 further includes exteroceptive sensors 6 fastened on the support frame 4 and configured to detect information on the environment in which the autonomous robotic device 3 is located. For example, the exteroceptive sensors 6 may include one or several LiDAR sensor(s), and are in particular configured to detect obstacles located on the movement path of the autonomous robotic device 3.

The autonomous robotic device 3 further comprises a control unit 7, formed for example by an electronic microcontroller, which is configured to process and analyze the information detected by the exteroceptive sensors 6 in order to identify characteristics of the environment in which the autonomous robotic device 3 is located, and which is also configured to control, in an autonomous control mode, the autonomous robotic device 3 based in particular on the information detected by the exteroceptive sensors 6.

Advantageously, the autonomous robotic device 3 includes a rechargeable battery (not shown in the figures) configured to electrically power the autonomous robotic device 3.

The monitoring system 2 also includes a support device 8, such as a support carriage, which securely moves with the autonomous robotic device 3, and which is for example fastened to the support frame 4 of the autonomous robotic device 3. According to the embodiment represented in FIGS. 1 to 9, the support device 8 is equipped with casters 9 configured to roll on the floor.

The monitoring system 2 further includes a mast 11 which is supported by the support device 8. The mast 11 advantageously has a length 15 greater than six meters, and being able for example to reach about ten meters.

The mast 11 may advantageously be at least partially formed by an assembly of mast sections which are removably nested into each other. Each mast section has for example a length comprised between 1.5 meters and 2.5 meters, and for example of about 2 meters.

The mast 11 is more particularly connected to the support device 8 by an articulation 12 with two degrees of freedom which is configured to allow a pivoting of the mast 11 relative to the support device 8 about a first articulation axis A1 and about a second articulation axis A2 which is perpendicular to the first articulation axis A1. Advantageously, the first and second articulation axes A1, A2 extend perpendicular to a longitudinal axis B of the mast 11, and are configured to allow roll and pitch movements of the mast 11. The articulation 12 may for example be located at a height comprised between 1.5 m and 2 m relative to the ground on which the autonomous robotic device 3 is intended to move.

As shown in FIG. 5, the articulation 12 includes a first fastening part 12.1 which is annular and which is mounted articulated on the support device 8 about the first articulation axis A1, and a second fastening part 12.2 which is annular and surrounded by the first fastening part 12.1 and which is mounted articulated on the first fastening part 12.1 around the second articulation axis A2. The second fastening part 12.2 extends around the mast 11 and is fastened to the mast 11. Advantageously, the first and second fastening parts 12.1, 12.2 extend coaxially when the mast 11 extends vertically.

As shown in FIGS. 1, 2 and 6, the mast 11 is configured to occupy a first mast position in which the mast 11 extends substantially vertically, and a second mast position in which the mast extends horizontally.

The monitoring system 2 further includes a counterweight 13 which is fastened to a lower portion 11.1 of the mast 11. Advantageously, the counterweight 13 is located below the articulation 12 when the mast 11 occupies the first mast position, and the mast 11 is configured such that the center of gravity of the mast 11 is located substantially at the level of the articulation 12.

The monitoring system 2 includes a movement limiting device 14 configured to limit an amplitude of movement of the mast 11 about the first articulation axis A1 when the mast 11 occupies the first mast position, and to limit an amplitude of movement of the mast 11 about the second articulation axis A2 when the mast 11 occupies the first mast position. Advantageously, the movement limiting device 14 is provided on the support device 8.

According to the embodiment represented in FIGS. 1 to 9, the movement limiting device 14 includes a rear stop member 14.1 removably fastened to the support device 8 and against which a lower portion of the mast 11 could come into abutment. when the mast 11 is pivoted about the first articulation axis A1 such that the lower portion of the mast 11 is away from the autonomous robotic device 3.

The movement limiting device 14 further includes two lateral stop members 14.2 provided on the support device 8 and against each of which the lower part of the mast 11 could come into abutment when the mast 11 is pivoted about the second articulation axis A2.

The monitoring system 2 further includes an immobilization device 15 configured to immobilize the mast 11 with respect to the support device 8 when the mast 11 occupies the second mast position.

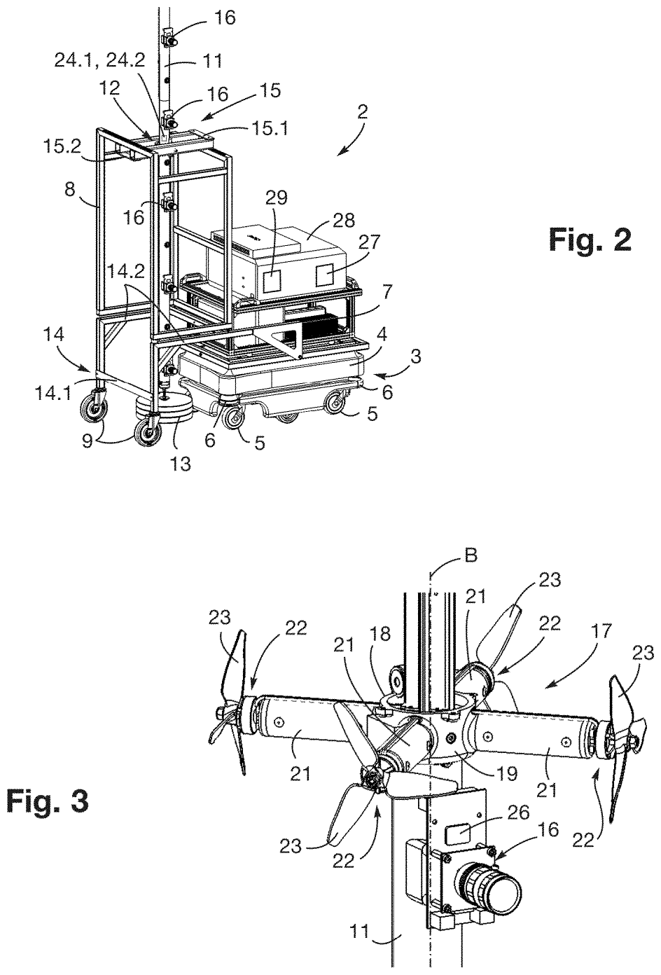

As shown more particularly in FIG. 2, the immobilization device includes a first immobilization member 15.1 removably fastened to the support device 8 and a second immobilization member 15.2 also removably fastened to the support device 8. The first and second immobilization members 15.1, 15.2 are configured to extend on either side of the mast 11 when the mast 11 is in the second mast position, so as to prevent any pivoting of the mast 11 about the second articulation axis A2. According to the embodiment represented in the figures, the first and second immobilization members 15.1, 15.2 extend substantially parallel to the first articulation axis A1, and are offset vertically with respect to each other.

In order to immobilize the mast 11 in the second mast position, all it needs is to dismantle, and for example to unscrew, the first and second immobilization members 15.1, 15.2, to pivot the mast 11 around the first articulation axis A1 until positioning the mast 11 in the second mast position, and finally to fasten the first and second immobilization members 15.1, 15.2 again to the support device 8.

According to the embodiment represented in FIGS. 1 to 9, the monitoring system 2 further includes image capturing devices 16 which are fastened to the mast 11 and which are configured to capture images of the area of interest during of the displacements of the autonomous robotic device 3.

Advantageously, the image capturing devices 16 are offset relative to each other along the longitudinal axis B of the mast 11, and are aligned with respect to each other along the longitudinal axis B of the mast 11. For example each image capturing device 16 may include a digital photographic camera or a digital camera.

The monitoring system 2 further includes a stabilization device 17 configured to vertically stabilize the mast 11 during the displacements of the autonomous robotic device 3. The stabilization device 17 advantageously includes a drone 18 which is fastened to the mast 11, and for example to an upper portion of the mast 11.

As shown more particularly in FIG. 3, the drone 18 includes in particular a central portion 19 which is fastened to the mast 11, a plurality of support arms 21 which are fastened to the central portion 19 and which are angularly offset from each other, and a plurality of airflow generation devices 22 which are each fastened to a respective support arm 21.

According to the embodiment represented in FIGS. 1 to 9, the support arms 21 extend in the same extension plane, and each airflow generation device 22 includes a propeller 23 having an axis of rotation which is substantially parallel to the direction of extension of the respective support arm 21, and a drive motor (not shown in the figures) configured to drive the respective propeller 23 in rotation. Advantageously, the axis of rotation of each propeller 23 extends substantially radially relative to the longitudinal axis of the mast 11.

For example, each support arm 21 may be hollow so as to enable the passage of electric power cables configured to electrically power the respective air flow generation device, and the reception of the respective drive motor.

The stabilization device 17 further includes an inertial unit 24.1 including at least one movement sensor configured to detect movements of the mast 11 relative to the terrestrial frame of reference, namely gravity. More particularly, the stabilization device 17 is configured to control the propellers 23 of the drone 18 according to the data detected by the inertial unit, and in particular according to the movements detected by the movement sensor.

Advantageously, the inertial unit 24.1 is located near the articulation 12. Such a positioning of the inertial unit 24.1 allows the stabilization device 17 to be more sensitive to the displacements of the mast 11, and therefore to ensure optimum control of the propellers 23, which makes it possible to ensure optimum stabilization of the mast 11. The inertial unit 24.1 may for example be fastened to the mast 11.

The stabilization device 17 further includes an automatic pilot 24.2 which is also located near the articulation 12 and which is configured to transmit control signals to the drone 18. The control signals are advantageously defined in particular according to the data detected by the inertial unit 24.1.

According to the embodiment represented in FIGS. 1 to 9, the monitoring system 2 also comprises a plurality of light sources 25 fastened to the mast 11. Advantageously, the light sources 25 are offset with respect to each other along the longitudinal axis B of the mast 11, and are aligned with respect to each other along the longitudinal axis B of the mast 11. Each light source 25 may include at least one light-emitting diode, and may for example be a light-emitting diode flash.

Advantageously, each light source 25 is located near an image capturing device 16 and is configured to at least partially illuminate a field of view of the respective image capturing device 16 in order to improve the quality of the images captured by said image capturing device 16. According to an embodiment of the invention, each light source could be located between two adjacent image capturing devices 16, and be configured to at least partially illuminate the fields of view of the adjacent image capturing devices 16.

According to the embodiment shown in FIGS. 1 to 9, the monitoring system 2 further comprises a plurality of light intensity measuring devices 26 fastened to the mast 11. Advantageously, the light intensity measuring devices 26 are offset with respect to each other along the longitudinal axis B of the mast 11, and are aligned with respect to each other along the longitudinal axis B of the mast 11.

Each light intensity measuring device 26 is located near an image capturing device 16 and is configured to measure a light intensity near the respective image capturing device 16.

According to the embodiment represented in FIGS. 1 to 9, the monitoring system 2 further comprises a setting unit 27 configured to set the light intensity of each light source 25 according to the light intensity measured by the device light intensity measuring device 26 which is located near the image capturing device 16 associated with said light source 25. These arrangements make it possible to improve the quality of the images captured by each image capturing device 16, while limiting the electrical consumption of the monitoring system 2, since it is not necessary to electrically power some light sources 25 when the light intensity at these light sources 25 is enough.

The monitoring system 2 comprises an on-board computer 28, for example fastened to the support device 8, which comprises the setting unit 27 and a processing unit 29. The processing unit 29 is configured for:
process and analyze the images captured by the image capturing devices 16, and
detect any faults in the surrounding structure, such as faults in the facade of the surrounding structure if the latter is a building or faults in a working face of the surrounding structure if the latter is a quarry, from captured images.

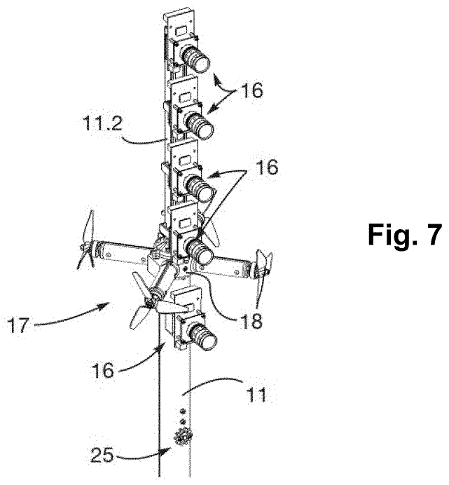

As shown in FIGS. 7 to 9, the mast 11 further includes a telescopic upper portion 11.2 which is located above the drone 18, and which is fastened to the central portion 19 of the drone 18. Advantageously, the telescopic upper portion 11.2 extends parallel to the main portion of the mast 11 and is equipped with several image capturing devices 16.

The telescopic upper portion 11.2 of the mast is deployable between a deployed configuration (cf. FIG. 9) in which the image capturing devices 16 carried by the telescopic upper portion 11.2 are away from each other and a retracted configuration (cf. FIG. 7) in which the image capturing devices 16 carried by the telescopic upper portion 11.2 are brought close to each other. Advantageously, the monitoring system 2 includes drive means configured to displace the telescopic upper portion 11.2 between the deployed and retracted configurations.

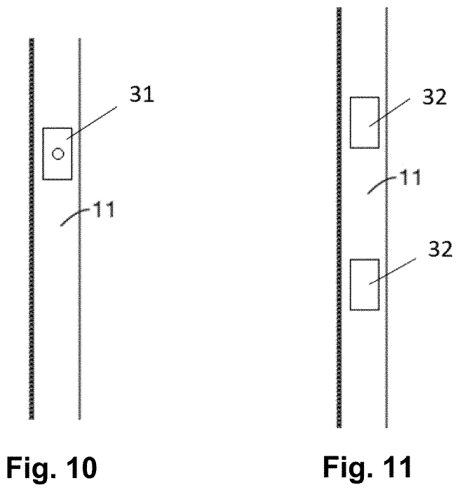

FIG. 10 represents a monitoring system 2 according to a second embodiment of the present invention which differs from the first embodiment essentially in that the monitoring system 2 is configured to monitor an operation state of one or several device(s) to be monitored located near the monitoring system 2.

The monitoring system 2 is more particularly configured to monitor an operation state of one or several smoke detection device(s). To this end, the monitoring system 2 includes a smoke spray device 31 configured to spray the smoke near the smoke detection device. The smoke spray device 31 advantageously securely moves with the mast 11, and may for example be fastened to the mast 11 or to one of the support arms 21.

FIG. 11 represents a monitoring system 2 according to a third embodiment of the present invention which differs from the first embodiment essentially in that the monitoring system 2 is configured to monitor the quality of the environment located around the monitoring system 2, and for example the air quality of said environment. To this end, the monitoring system 2 includes one or several environmental sensor(s) 32 configured to detect the presence of predetermined particles in the air of the environment located around the monitoring system, and for example toxins, pollutants, chemicals, smoke. Advantageously, the environmental sensor(s) 32 is/are fastened to the mast 11.

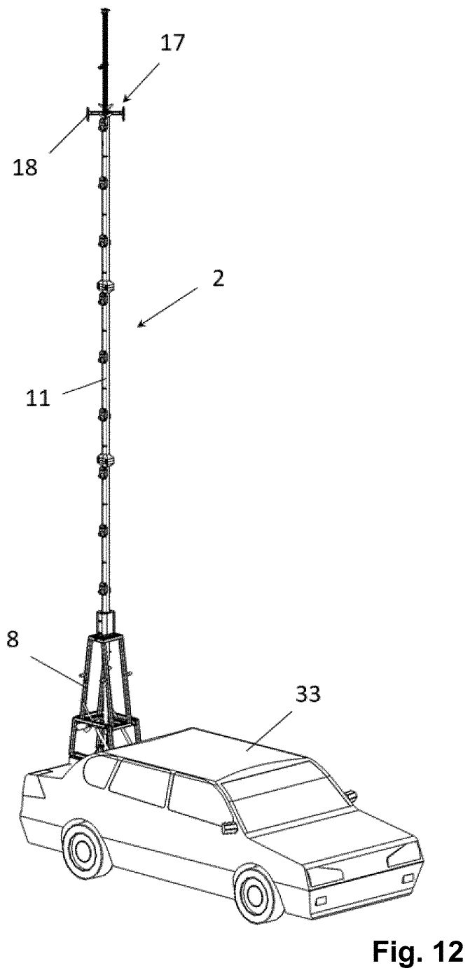

FIG. 12 represents a monitoring system 2 according to a fourth embodiment of the present invention which differs from the first embodiment essentially in that the monitoring system 2 does not have an autonomous robotic device and in that the support device 8 is fastened to a motor vehicle 33, such as a car, a truck or all-purpose vehicle. The support device 8 could also be fastened to other types of vehicles, and in particular to other types of motor vehicles, such as a boat or a train.

It goes without saying that the invention is not limited to the sole embodiments of this monitoring system, described hereinabove as examples, but on the contrary, it encompasses all the variants. Thus, in particular, the articulation 12 could be an articulation with three degrees of freedom, in other words a ball joint.

1. A monitoring system configured to monitor an area of interest located near the monitoring system, the monitoring system comprising:
a support device which is displaceable,
a mast which is supported by the support device, the mast being connected to the support device by an articulation with at least two degrees of freedom, and
a stabilization device configured to vertically stabilize the mast during displacements of the support device, the stabilization device including a plurality of support arms which are fastened to the mast and which are angularly offset from each other, and a plurality of air flow generation devices which are fastened to the support arms.

2. The monitoring system according to claim 1, wherein the area of interest is a surrounding structure located near the monitoring system, and/or a device to be monitored located near the monitoring system and/or an environment around the monitoring system.

3. The monitoring system according to claim 2, which is configured to monitor a structural state of the surrounding structure, and/or to monitor an operation state of the device to be monitored and/or to monitor quality of the environment.

4. The monitoring system according to claim 1, wherein the articulation with at least two degrees of freedom is configured to enable a pivoting of the mast relative to the support device about a first pivot connection and about a second pivot connection substantially perpendicular to the first pivot connection.

5. The monitoring system according to claim 4, wherein the first and second pivot connections extend transversely to a longitudinal axis of the mast.

6. The monitoring system according to claim 1, wherein a counterweight is fastened to a lower portion of the mast, the counterweight being configured so as to place a center of gravity of a set formed by the mast and the counterweight near the articulation with two degrees of freedom.

7. The monitoring system according to claim 1, wherein the mast is configured to occupy a first mast position in which the mast extends substantially vertically, and a second mast position in which the mast extends substantially horizontally.

8. The monitoring system according to claim 7, which includes a movement limiting device configured to limit an amplitude of movement of the mast relative to the support device when the mast occupies the first mast position.

9. The monitoring system according to claim 7, which includes an immobilization device configured to immobilize the mast with respect to the support device when the mast occupies the second mast position.

10. The monitoring system according to claim 1, wherein the stabilization device includes at least one movement sensor configured to detect movements of the mast relative to a terrestrial frame of reference, the stabilization device being configured to control the air flow generation devices according to the movements detected by the at least one movement sensor.

11. The monitoring system according to claim 1, wherein the mast is at least partially formed by an assembly of mast sections which are removably nested into each other.

12. The monitoring system according to claim 1, wherein the mast is equipped with at least one image capturing device configured to capture images of the area of interest.

13. The monitoring system according to claim 1, wherein the support device is equipped with casters configured to roll on a floor on which the support device is intended to be displaced.

14. The monitoring system according to claim 1, which further includes an autonomous robotic device configured to move autonomously, the support device securely moving with the autonomous robotic device.

15. The monitoring system according to claim 3, wherein the articulation with at least two degrees of freedom is configured to enable a pivoting of the mast relative to the support device about a first pivot connection and about a second pivot connection substantially perpendicular to the first pivot connection.

16. The monitoring system according to claim 15, wherein the first and second pivot connections extend transversely to a longitudinal axis of the mast.

17. The monitoring system according to claim 16, wherein a counterweight is fastened to a lower portion of the mast, the counterweight being configured so as to place a center of gravity of a set formed by the mast and the counterweight near the articulation with two degrees of freedom.

18. The monitoring system according to claim 17, wherein the mast is configured to occupy a first mast position in which the mast extends substantially vertically, and a second mast position in which the mast extends substantially horizontally.

19. The monitoring system according to claim 18, which includes a movement limiting device configured to limit an amplitude of movement of the mast relative to the support device when the mast occupies the first mast position.

20. The monitoring system according to claim 19, which includes an immobilization device configured to immobilize the mast with respect to the support device when the mast occupies the second mast position.
